(19) United States
(12) Patent Application Publication
(10) Pub. No.: US 2026/0051227 A1
(43) Pub. Date: Feb. 19, 2026

(54) INTEGRATED AND SYNCHRONIZED GAMING SYSTEM AND METHODS

(71) Applicant: Primero Games, LLC, Norcross, GA (US)

(72) Inventor: Michael Mayo Macke, Norcross, GA (US)

(21) Appl. No.: 19/292,232

(22) Filed: Aug. 6, 2025

Related U.S. Application Data
(60) Provisional application No. 63/683,532, filed on Aug. 15, 2024.

(51) Int. Cl. G07F 17/32

(52) U.S. Cl. CPC G07F 17/329; G07F 17/3216

(57) ABSTRACT

A computing device can determine a game subset from a plurality of indicia and a winning pattern from a plurality of patterns for a wagering game. The computing device can receive a request to play the wagering game and generate a card comprising a card subset from the plurality of indicia arranged in a randomly assigned order. The computing device can determine an outcome by printing the card including a QR code, scanning the QR code from the printed card, and in response to scanning the QR code, identifying a card resulting subset as an intersection of the game subset and the card subset. The computing device can perform a comparison of the card resulting subset as arranged in the randomly assigned order to the plurality of patterns and determine an award for the card based on the comparison.

### CROSS-REFERENCE TO RELATED APPLICATIONS

This application is a non-provisional application of, and claims the benefit of and priority to U.S. Provisional Patent Application No. 63/683,532, entitled “INTEGRATED AND SYNCHRONIZED GAMING SYSTEM AND METHODS,” filed on Aug. 15, 2024, the contents of which are incorporated herein by reference in its entirety.

### TECHNICAL FIELD

The present systems and processes relate to using computing technologies to provide a multiplatform a wagering game across mediums.

### BACKGROUND

Traditional wagering games use paper game cards. Although digital game play on gaming devices is available, some patrons wish to continue using paper game play. However, paper game play does not synchronize well with modern wagering systems. Therefore, there is a long-felt but unresolved need for synchronizing a wagering game across paper and digital game play, including across multiple, varied gaming apparatuses.

### BRIEF SUMMARY OF THE DISCLOSURE

Briefly described, and according to one embodiment, aspects of the present disclosure generally relate to an integrated and synchronized gaming system that allows for both paper game play and digital game play using one or more gaming devices. The gaming system can synchronize a single wagering game across both the paper game play and the digital game play. The gaming system can initiate a single wagering game across both the paper game play and digital game play and terminate the single wagering game once a game ending event has occurred in either the paper game play or the digital game play.

A gaming server can initiate and terminate the wagering game. The gaming server can be in communication with one or more gaming devices, including gaming kiosks for enabling paper play, gaming devices for digital play, and mobile gaming devices for digital play on a mobile computing device. The gaming server can initiate the wagering game by determining a game subset and a winning pattern. The game subset can be selected from a defined set of indicia, which can include a set of numbers, letters, and/or symbols. The game subset can be selected by using a random selection process, including but not limited to, random number generator or by manual or automated ball selection methods.

A request to play the wagering game can be received at a gaming apparatus. The gaming apparatus can select a card subset from the defined set of indicia by using a random selection process. The card subset can refer to a subset of the set of indicia to be placed at the various positions on the grid and/or a game board, such as a bingo card. The gaming apparatus can print a card with the card subset arranged in a pattern and optionally with the game subset. The user can optionally fill in the card by marking the indicia included in both the game subset and the card subset and scan a QR code included on the card.

The gaming apparatus can determine the outcome by comparing the card subset to the game subset. If the card subset includes any indicia contained within the game subset and the contained indicia are arranged in a winning pattern, the system can determine the outcome as a winning outcome. If the card subset does not include any indicia included in the game subset or the matching indicia are not arranged in a winning pattern, the outcome can include a losing outcome. If the system can determine the outcome as a winning outcome, the system can determine an award based on the outcome.

The gaming apparatus can transmit the outcome to the gaming server. If the outcome included the matching indicia arranged in a game winning pattern, the gaming server can terminate the wagering game. The gaming server can transmit a game terminated message to the gaming apparatuses and instruct the gaming apparatuses to pause accepting requests to play the wagering game until a new wagering game is initiated.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a wagering game card set according to various embodiments of the present disclosure.

FIG. 2 illustrates an exemplary networked environment for the disclosed system according to various embodiments of the present disclosure.

FIG. 3 illustrates an exemplary wagering game process for the disclosed system according to various embodiments of the present disclosure.

FIG. 4 illustrates an exemplary wagering game process for the disclosed system according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to an integrated and synchronized gaming system. The gaming system can allow for both paper game play and digital game play using one or more gaming devices. The gaming system can synchronize a single wagering game across both the paper game play and the digital game play. Said another way, the gaming system can initiate a single wagering game across both the paper game play and digital game play and terminate the single wagering game once a game ending event has occurred in either the paper game play or the digital game play.

A gaming server can initiate and terminate the wagering game. The gaming server can be in communication with one or more gaming devices, including gaming kiosks for enabling paper play, gaming devices for digital play, and mobile gaming devices for digital play on a user's personal computing device (collectively “gaming apparatuses”). The gaming server can initiate the wagering game by determining a game subset and a winning pattern. The game subset can be selected from a defined set of indicia. The defined set of indicia can include a set of numbers (e.g., integers), letters, and/or symbols (e.g., a distinct, visual indicator). For example, the defined set of indicia can include a set numeral representation, such as integers 0 to 100, and the game subset can include 20 randomly selected integers from the defined set. The game subset can be selected by using a random selection process, including but not limited to, random number generator or by manual or automated ball selection methods. For example, the system can identify specific indicia from the defined set by mapping probabilities to each indicia and selecting the indicia using a random number generator. The system can select one or more winning patterns from a defined set of patterns. The defined set of patterns can include a set of patterns on a grid of squares. The grid can include any number of rows and any number of columns. The patterns can be visually illustrated by filling in the squares on the grid. As an illustrative, non-limiting example, the grid can include a 5 by 5 grid of squares, and a pattern can include a symmetrical cross (e.g., all 5 of the squares in the center column, all 5 squares in the middle row). As another illustrative, non-limiting example, the pattern can include the single square in the upper right-hand corner of the grid. The grid can be displayed on a wagering game board. As an example, a winning pattern can correspond to a set of positions on the grid of a wagering game board that need to be selected for a winning outcome. As will be understood, the game subset and the winning patterns can be used to determine the outcome for the wagering game. For example, the wagering game can be won if indicia from the game subset are arranged in the winning pattern on the grid. The gaming server can transmit the game subset and the winning patterns to the gaming apparatuses. The gaming apparatuses can display a message indicating that the wagering game has been initiated and the game subset and the winning patterns.

A request to play the wagering game can be received at a gaming apparatus. The gaming apparatus can select a card subset from the defined set of indicia by using a random selection process (e.g., random number generator, random shuffling and selection of n indicia). The card subset can refer to a subset of the set of indicia to be placed at the various positions on the grid and/or a game board, such as a bingo card. The gaming apparatus can print a card with the card subset arranged in a pattern and optionally with the game subset. In some embodiments, the gaming apparatus may print a card only when the gaming apparatus is a gaming kiosk. In other embodiments, other gaming apparatuses can print the card. The user can optionally fill in the card and scan a QR code included on the card. For example, the card can be filled by marking (e.g., with an X, cross, other marking) the indicia included in both the card subset and the game subset. The gaming apparatus can determine the outcome by comparing the card subset to the game subset. If the card subset includes any indicia contained within the game subset and the contained indicia are arranged in a winning pattern (e.g., a game winning pattern or an interim winning pattern), the system can determine the outcome as a winning outcome. If the card subset does not include any indicia included in the game subset or the matching indicia (e.g., the indicia included in both the card subset and the game subset) are not arranged in a winning pattern, the outcome can include a losing outcome. If the system can determine the outcome as a winning outcome, a prize may be awarded.

The gaming apparatus can transmit the outcome to the gaming server. If the outcome included the matching indicia arranged in a game winning pattern, the gaming server can terminate the wagering game. The gaming server can transmit a game terminated message to the gaming apparatuses and instruct the gaming apparatuses to pause accepting requests to play the wagering game until a new wagering game is initiated.

### Exemplary Embodiments

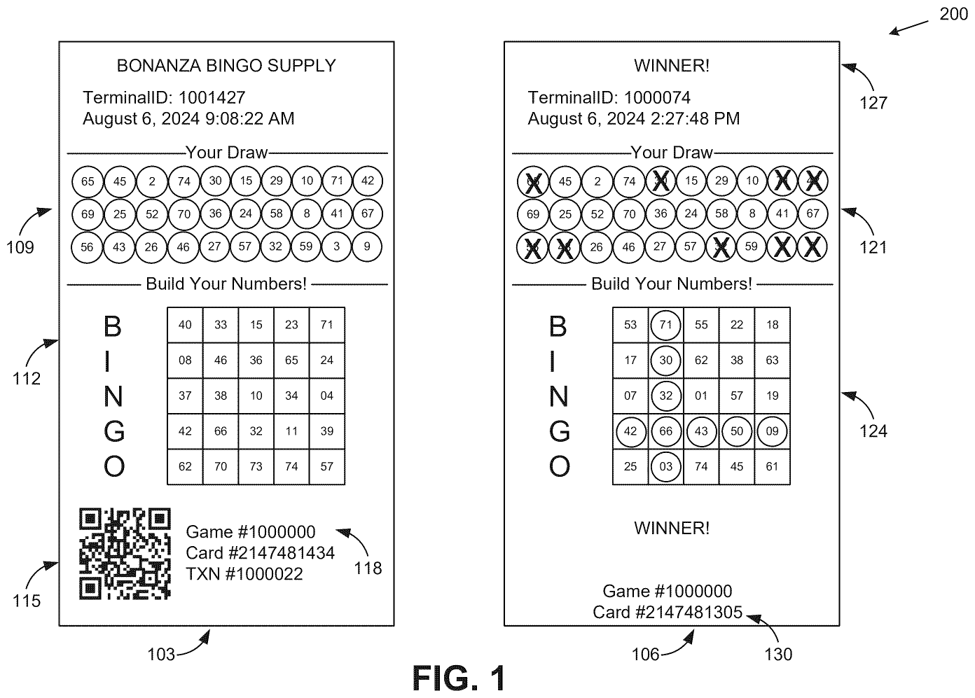

Referring now to the figures, for the purposes of example and explanation of the fundamental processes and components of the disclosed systems and processes, reference is made to FIG. 1, which illustrates the wagering game card set 100 (“set 100”). The set 100 can include a method for playing a wagering game in an integrated and synchronized gaming system (“gaming system”).

The set 100 can include a first card 103 and a second card 106. The first card 103 can include the game subset 109. The gaming system can initiate a wagering game by selecting the game subset 109 from a defined set of indicia. The defined set of indicia can include any number of integers, letters, and/or symbols. For example, the defined set of indicia can include integers 0 through 100. The gaming system can select the game subset 109 from the defined set of indicia by using a randomized selection process (e.g., the game subset 109 is randomly selected from the defined set of indicia). The game subset 109 can include any number of indicia that is less than or equal to the number of indicia included in the defined set. For example, the gaming system can select the game subset 109 with a manual process using balls representing each of the indicia in the defined set (e.g., selecting balls from a cage, selecting balls using a ball blower) or a digital process using a random number generator. As another example, the gaming system can select the game subset 109 by shuffling (e.g., randomly ordering) the defined set of indicia and selecting the first n indicia (e.g., n represents the number of indicia included in the game subset 109). The game subset 109 can include any of the selected indicia from the defined set of indicia and can be printed on the first card 103.

The first card 103 can include a card subset 112. The card subset 112 can be selected from the defined set of indicia. For example, the card subset 112 can be randomly selected using a random number generator or by randomly shuffling the defined set of indicia and selecting the first n indicia (e.g., n represents the number of indicia included in the card subset 112). The card subset 112 can be organized or arranged in a random order by a random number generator. For example, the card subset 112 can be randomly organized into a grid and printed on the first card 103. In one embodiment, the system can generate the card subset 112 position by position. For example, the system can randomly select 40 for the first position of card subset 112 and subsequently select 33 for the next position of card subset 112. As another example, the card subset 112 can be selected based on a user input. The card subset 112 can include any number of indicia that is less than or equal to the number of indicia included in the defined set. In some embodiments, the selection of the indicia can be performed without replacement. As an example, in some embodiments, each indicia selected is removed from the list of selectable indicia such that each indicia is selectable only once per card. For example, each indicia included in the defined set can be included in the card subset 112 once. In some other embodiments, each indicia included in the defined set can be included in the card subset 112 multiple times.

The first card 103 can include a scannable code 115. For example, the scannable code can include a barcode or a QR code. The first card 103 can include an identifier 118. The identifier 118 can include a game identifier and a card identifier. The game identifier can represent the game associated with the first card 103. The card identifier can be unique to a particular first card 103.

A user can request the first card 103 from the gaming system. The gaming system can include one or more gaming devices and gaming kiosks as discussed further herein. For example, a user can request the first card 103 from a gaming kiosk or from any of the gaming apparatuses. In some embodiments, both the first card 103 and the second card 106 can include a printed, physical card or a digital card rendered on a display. After receiving the first card 103, the user can optionally complete the card subset 112 by marking any of the indicia in the card subset 112 that are also included in the game subset 109. For example, the user can mark indicia in the card subset 112 that match the game subset 109. The gaming kiosk can scan the scannable code 115, and in response, display a game outcome on a display associated with the gaming kiosk and print the second card 106.

The second card 106 can include a marked game subset 121 and a marked card subset 124. Both the marked game subset 121 and the marked card subset 124 can include the same indicia included in the game subset 109 and the card subset 112, respectively. In addition to the same indicia included in the game subset 109 and the card subset 112, the marked game subset 121 and the marked card subset 124 can include symbols indicating matching indicia between the game subset 109 and the card subset 112. For example, if any of the indicia in the card subset 112 match the indicia in the game subset 109, the matching indicia can include a symbol (e.g., a cross, an X, a circle) indicating the match on the marked game subset 121 and the marked card subset 124.

The second card 127 can include an outcome 127. The outcome 127 can depend on if the card subset 112 includes any indicia matching the game subset 109 and if the matching indicia are arranged in a defined pattern (e.g., a winning pattern). The card subset 112 can be randomly organized into an order or a grid. If the matching indicia included in the card subset 112 (e.g., the indicia matching the card subset 112) are arranged in a defined pattern, the outcome 127 can include a winning outcome. The gaming system can include multiple defined patterns. For example, the defined patterns can include any pattern of matching indicia in the card subset 112 arranged in a grid. When initiating the wagering game, the gaming system can select one or more of defined patterns as game winning patterns. If the matching indicia in the card subset 112 are arranged in the game winning pattern on the first card 103, the outcome 127 can include a winning outcome and the gaming system can terminate the wagering game. The gaming system can select one or more defined patterns as interim winning patterns. If the matching indicia in the card subset 112 are arranged in the interim winning pattern on the first card 103, the outcome 127 can include a winning outcome (e.g., an interim winning outcome), but the gaming system may not terminate the wagering game (e.g., the gaming system may continue the wagering game). For example, if the outcome includes an interim winning outcome, the gaming system can assign the wagering game to a level for a progressive.

The second card 106 can include an identifier 130. The identifier 130 can include a game identifier and a card identifier. The game identifier on the second card 106 can match the game identifier on the first card 103 because the second card 106 and the first card 103 can be associated with the same wagering game. The card identifier can be unique to a particular second card 106.

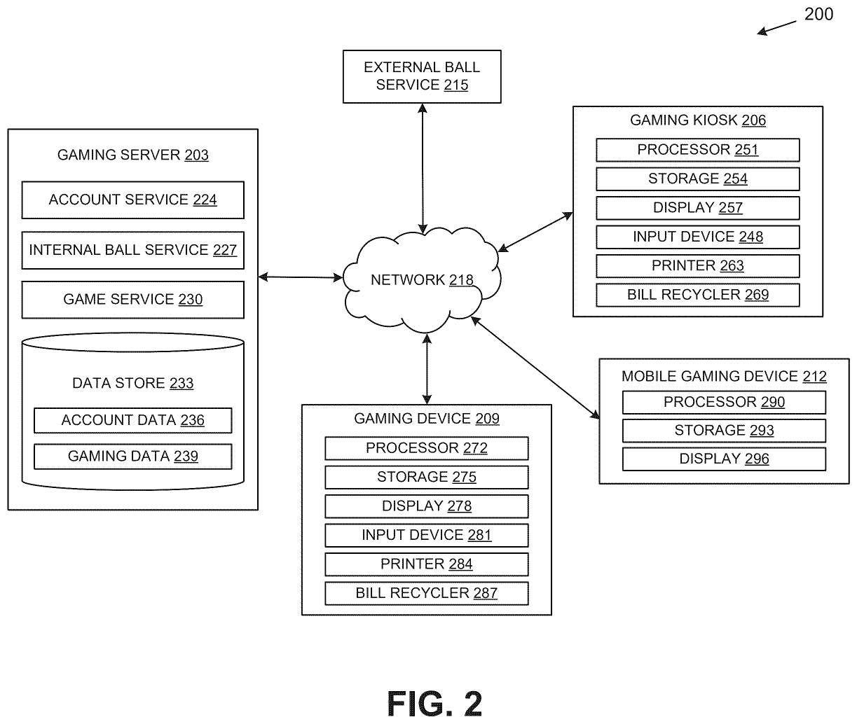

Referring now to FIG. 2, shown is an exemplary gaming system 200 for the gaming system according to various embodiments of the present disclosure. As will be understood and appreciated, the exemplary gaming system 200 shown in FIG. 2 represents merely one approach or embodiment of the present system, and other aspects are used according to various embodiments of the present system. Exemplary gaming system 200 can include, but is not limited to, a gaming server 203, one or more gaming kiosks 206, one or more gaming device 209, one or more mobile gaming devices 212, and an external ball service 215 all connected by a network 218.

The elements of the gaming server 203 can be provided via one or more computing devices that may be arranged, for example, in one or more server banks or computer banks or other arrangements. Such computing devices can be located in a single installation or may be distributed among many different geographical locations. For example, the gaming server 203 can include one or more computing devices that together may include a hosted computing resource, a grid computing resource, or any other distributed computing arrangement. In some cases, the gaming server 203 can correspond to an elastic computing resource where the allotted capacity of processing, network, storage, or other computing-related resources may vary over time. Regardless, the gaming server 203 can include one or more processors and memory having instructions stored thereon that, when executed by the one or more processors, cause the gaming server 203 to perform one, some, or all of the actions, methods, steps, or functionalities provided herein.

The gaming server 203 can include an account service 224, an internal ball service 227, a game service 230, and the data store 233. The account service 224, the internal ball service 227, and the game service 230 can correspond to one or more software executables that can be executed by the computing environment 203 to perform the functionality described herein. While the account service 224, the internal ball service 227, and the game service 230 are described as different services, it can be appreciated that the functionality of these services can be implemented in one or more different services executed in the gaming server 203. Various data can be stored in the data store 233, including but not limited to the account data 236 and the gaming data 239.

The account service 224 can receive an account identifier (e.g., PIN number, account number, account username, email address, phone number) and/or account credentials from the gaming kiosk 206, the gaming device 209 and/or the mobile gaming device 212. The account service 224 can authenticate the user by comparing the account identifier and/or the account credentials to the account data 236. In some other embodiments, the gaming kiosk 206, the gaming device 209 and/or the mobile gaming device 212 receive the account identifier and/or account credentials via input. In other embodiments, the gaming kiosk 206 and/or the gaming device 209 can receive the account identifier and/or account credentials via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming kiosk 206 and/or the gaming device 209 to receive the account identifier and/or account credentials. In another embodiment, the gaming kiosk 206 and/or the gaming device 209 can read the account identifier associated with the patron from using near field communication (NFC).

The internal ball service 227 can select the game subset and the winning pattern using a random number generator. For example, the internal ball service 227 can generate a random number between 1 and the number of balls and select a ball corresponding to that number where the balls include a ball for each of the set of indicia. As another example, the internal ball service 227 can select the winning pattern from a set of defined patterns using a random number generator. The internal ball service 227 can select one or more game winning patterns and one or more interim winning patterns from the set of defined patterns. The game subset, the winning patterns, the defined set of indicia, and the defined set of patterns can be saved as the gaming data 239.

The game service 230 can select the card subset using a random number generator. For example, the card subset can be selected from the defined set of indicia by using a random number generator. The card subset can be organized or arranged in a random order by the random number generator. The game service 230 can compare the card subset to the game subset to identify any matching indicia. Based on the comparison, the game service 230 can determine an outcome for the wagering game. If the card subset includes any indicia matching the game subset and the matching indicia are arranged in a winning pattern (e.g., a game winning pattern or an interim winning pattern), the outcome can include a winning outcome. If the card subset does not include any indicia matching the game subset or the matching indicia are not arranged in a winning pattern, the outcome can include a losing outcome. The outcome can be saved as the account data 236 and the gaming data 239.

The game service 230 can initiate and terminate the wagering game. The game service 230 can initiate the wagering game by instructing the internal ball service 227 to select the game subset and the winning pattern. In other embodiments, the game service 230 can initiate the wagering game by instructing the external ball service 215 to select the game subset. The game service 230 can transmit the game subset and the winning pattern to the gaming kiosk 206, the gaming device 209, and the mobile gaming device 212. If the card subset includes matching indicia arranged in a game winning pattern, the game service 230 can terminate the wagering game. The game service 230 can transmit a game termination message to the gaming kiosk 206, the gaming device 209, and the mobile gaming device 212 and instruct the gaming kiosk 206, the gaming device 209, and the mobile gaming device 212 to pause accepting requests to play the wagering game. After the wagering game has been terminated, the game service 230 can initiate a new wagering game.

According to various embodiments, the gaming kiosk 206 can include any device capable of accessing network 218 including, but not limited to, a computer, smartphone, tablets, or other device. The gaming kiosk 206 can include a processor 251 and storage 254. The gaming kiosk 206 can include a display 257 on which various user interfaces can be rendered to facilitate play of the wagering game by one or more user. The user can provide inputs to play the wagering game via the input device 260. In various embodiments, gaming kiosk 206 can include multiple computing devices. Regardless, the gaming kiosk 206 can include one or more processors and memory having instructions stored thereon that, when executed by the one or more processors, cause the gaming kiosk 206 to perform one, some, or all of the actions, methods, steps, or functionalities provided herein. The gaming kiosk can include a printer 263. The printer 263 can be a thermal printer, an ink printer, a laser printer, or other type of printer. The printer 263 can print the tickets illustrated by the first card 103 and the second card 106 in FIG. 1. The gaming kiosk can include a bill recycler 269. The bill recycler 269 can accept the wager and pay out the award.

The gaming kiosk 206 can receive requests to play the wagering game and determine the outcome for the wagering game. The gaming kiosk 206 can receive requests to play the wagering game via the input device 260 and can accept the wager via the bill recycler 269. The gaming kiosk 206 can generate a card by determining a card subset. For example, the gaming kiosk 206 can select the card subset from the defined set of indicia using a random number generator. The gaming kiosk 206 can determine an order for the card subset based on the random number generator. The gaming kiosk 206 can print the card as the first card 103 illustrated by FIG. 1. The card printed by the gaming kiosk 206 can display the card subset in the order arranged in a grid. The gaming kiosk 206 can scan the card to determine an outcome. The gaming kiosk 206 can compare the card subset to the game subset to identify any matching indicia. If the card subset includes any indicia matching the game subset and the matching indicia are arranged in a winning pattern (e.g., a game winning pattern or an interim winning pattern), the outcome can include a winning outcome. If the card subset does not include any indicia matching the game subset or the matching indicia are not arranged in a winning pattern, the outcome can include a losing outcome. The gaming kiosk 206 can determine an award based on the outcome and print the outcome on the second card 206 illustrated by FIG. 1. In some embodiments, the gaming server 203 can operate on the gaming kiosk 206 and the gaming kiosk 206 can perform the functionality of the gaming server 203.

According to various embodiments, the gaming device 209 can include any device capable of accessing network 218 including, but not limited to, a computer, smartphone, tablets, or other device. The gaming device 209 can be a gaming cabinet, an amusement device, a slot machine, or other gaming device with a processor-based system such as a computer system. The gaming device 209 can include a processor 272 and storage 275. The gaming device 209 can include a display 278 on which various user interfaces can be rendered to allow users play the wagering game. The gaming device 209 can include the input device 281 for a user to provide various inputs (e.g., wagers, credentials). The input device 281 can include one or more buttons, touch screens including three-dimensional or pressure-based touch screens, camera, finger print, scanners, accelerometer, retinal scanner, gyroscope, magnetometer, or other input devices. The gaming device 209 can include a printer 284 for printing the first card 103 and the second card 106 as illustrated by FIG. 1. The printer 284 can print tickets for redeeming the award associated with the wagering game. The gaming device 209 can include a bill acceptor 287 for accepting the wager.

According to various embodiments, the mobile gaming device 212 can include any device capable of accessing network 218 including, but not limited to, a computer, smartphone, tablets, or other device. The mobile gaming device 212 can include a processor 290 and storage 293. The mobile gaming device 212 can include a display 296 on which various user interfaces can be rendered to allow users to play the wagering game. In various embodiments, mobile gaming device 212 can include multiple computing devices. Regardless, the mobile gaming device 212 can include one or more processors and memory having instructions stored thereon that, when executed by the one or more processors, cause the mobile gaming device 212 to perform one, some, or all of the actions, methods, steps, or functionalities provided herein.

The external ball service 215 can select the game subset using a manual ball process. For example, the external ball service 215 can use balls representing the indicia in the defined set to select the game subset. The external ball service 215 can use a ball cage or a ball blower to select the balls representing the indicia. The external ball service 215 can receive the selected indicia by manual input (e.g., a user manually enters the selected indicia based on the balls selected using a ball cage or a ball blower). In other embodiments, the external ball service 215 can include a scanner or camera that can automatically determine the selected indicia without manual input.

The network 218 includes, for example, the Internet, intranets, extranets, wide area networks (WANs), local area networks (LANs), wired networks, wireless networks, or other suitable networks, etc., or any combination of two or more such networks.

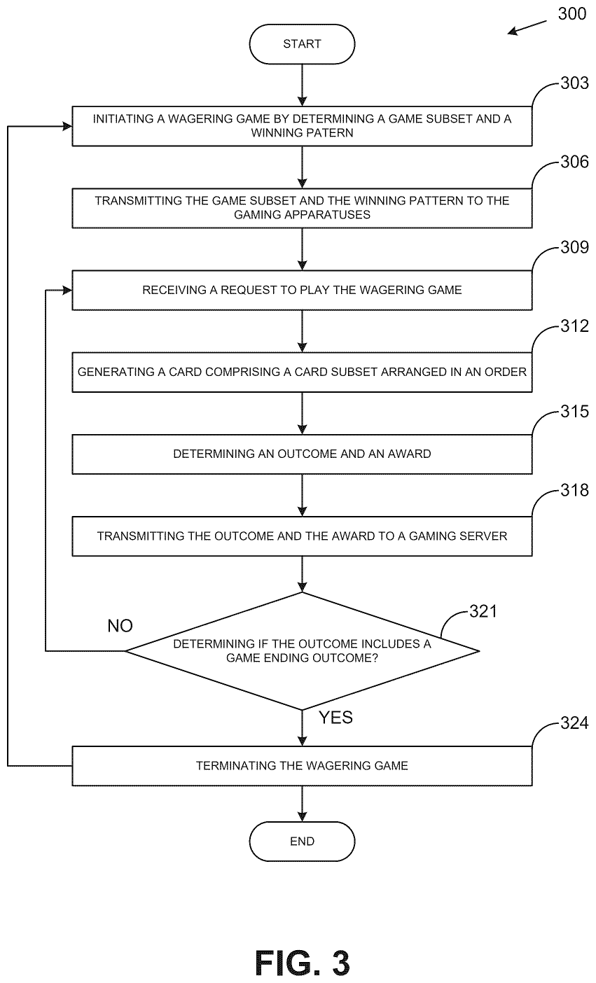

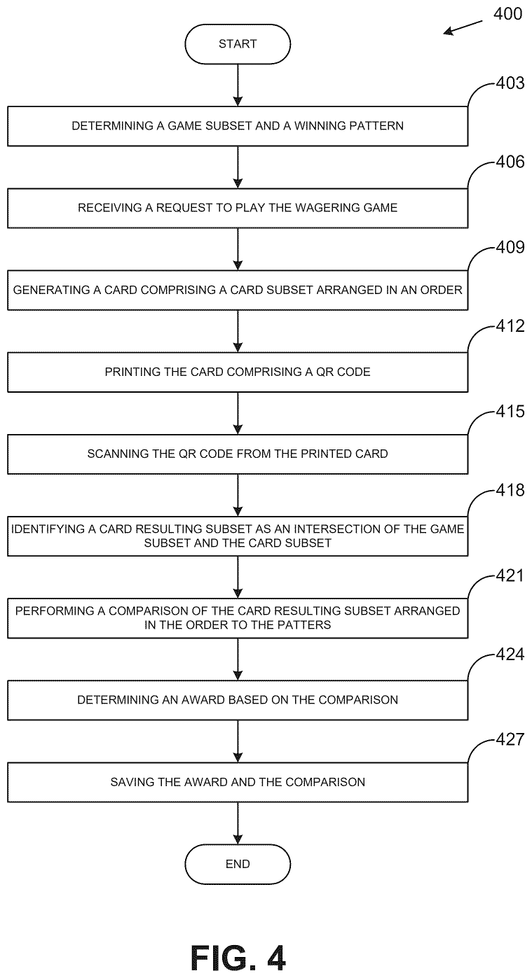

Referring now to FIG. 3, shown is an exemplary, wagering game process 300 according to various embodiments of the present disclosure. As will be understood by one having ordinary skill in the art, the steps and processes shown in FIGS. 3 and 4 may operate concurrently and continuously, are generally asynchronous and independent, can be performed in part or in whole by a combination of one or more of the gaming server 203, the gaming kiosks 206, the gaming devices 209, the mobile gaming devices 212, and the external ball service 215 and are not necessarily performed in the order shown and various steps can be executed linearly or in parallel. Process 300 can be performed entirely, partially, or in coordination with the account service 224, the internal ball service 227, and the game service 230. As will be understood, the steps and processes shown in FIGS. 3 and 4 can operate with multiple gaming kiosks 206, multiple gaming devices 209, and multiple gaming devices 212 all in communication with the gaming server 203. For the purposes of FIGS. 3 and 4, the multiple gaming kiosks 206, the multiple gaming devices 209, and the multiple mobile gaming devices 212 communicating with the gaming server 203 can be collectively referred to as the collective gaming apparatuses.

At step 303, the process 300 can include initiating a wagering game by determining a game subset and a winning pattern. The gaming server 203 can initiate the wagering game by determining a game subset and a winning pattern. In some embodiments, the gaming server 203 can determine the game subset by receiving the game subset from the external ball service 215. For example, the external ball service 215 can use balls representing the indicia in the defined set to select the game subset. The external ball service 215 can use a ball cage or a ball blower to select the balls representing the indicia. The external ball service 215 can receive the selected indicia by manual input (e.g., a user manually enters the selected indicia based on the balls selected using a ball cage or a ball blower). In other embodiments, the external ball service 215 can include a scanner or camera that can automatically determine the selected indicia without manual input.

In some other embodiments, the internal ball service 227 can use a digital random selection process to select the game subset. For example, the internal ball service 227 can select the game subset and the winning pattern using a random number generator. For example, the internal ball service 227 can select the game subset from the defined set of indicia using a random number generator. As another example, the internal ball service 227 can shuffle (e.g., randomly order the defined set of indicia) and select the first n indicia (e.g., n represents the number of indicia included in the game subset) based on a predefined rule. As another example, the internal ball service 227 can select the winning pattern from a set of defined patterns using a random number generator. As another example, the internal ball service 227 can select the winning pattern by randomly ordering the set of defined patterns. In some embodiments, the internal ball service 227 can generate a winning pattern by randomly selecting squares on a grid. In some other embodiments, the internal ball service 227 can select the game subset and the winning pattern based on a user input (e.g., the internal ball service 227 can anonymize the indicia in the defined set and the defined set of winning patterns for user selection). The internal ball service 227 can select one or more game winning patterns and one or more interim winning patterns from the set of defined patterns. The game subset and the winning patterns can be saved as the gaming data 239.

At step 306, the process 300 can include transmitting the game subset and the winning patterns to the collective gaming apparatuses. The gaming server 203 can transmit the game subset and the winning patterns to the collective gaming apparatuses. The gaming server 203 can transmit the game subset and the winning pattern to the multiple gaming kiosks 206, the multiple gaming devices 209, and the multiple mobile gaming devices 212 communicating with the gaming server 203. In response to receiving the game subset and the winning pattern from the gaming server 203, the collective gaming apparatuses can transmit a receipt confirmation to the gaming server 203. In some embodiments, the gaming server 203 can operate on a gaming kiosk 206 or a gaming device 209. In these embodiments, transmitting the game subset and the winning pattern to the gaming kiosk 206 and/or the gaming device 209 may be unnecessary.

At step 309, the process 300 can include receiving a request to play the wagering game. The collective gaming apparatuses can receive a request to play the wagering game. The request can be received by an input device on the respective gaming apparatus (e.g., gaming kiosk 206, gaming device 209, mobile gaming device 212) from a user. As will be understood, each of the collective gaming apparatuses can individually receive a request to play the wagering game and perform the steps 309-318. For example, if a gaming kiosk 206 receives a request to play the wagering game, the gaming kiosk 206 that received the request can perform the steps 309-318. For example, if a gaming device 209 receives a request to play the wagering game, the gaming device 209 that received the request can perform the steps 309-318. For example, if a mobile gaming device 212 receives a request to play the wagering game, the mobile gaming device 212 that received the request can perform the steps 309-318. Further, each of the collective gaming apparatuses can each receive one or more requests to play the wagering game from different users until the wagering game is won.

The request can include an account identifier (e.g., PIN number, account number, account username, email address, phone number) and/or account credentials. For example, the collective gaming apparatuses can transmit the account identifier and/or account credentials to the gaming server 203. The account service 224 can compare the account identifier and/or account credentials to the account data 236 and transmit a success or failure message to the collective gaming apparatuses based on the comparison. The request can include a number of plays. For example, the request can include one play or more than one plays (e.g., 2 plays, 5 plays, 10 plays, 100 plays). The request can include a wager (e.g., an amount being bet by the user for each play). The wager can include an amount of money or an amount of credits.

In some embodiments, each of the collective gaming apparatuses can receive an additional request related to the request to play the wagering game. For example, any of the collective gaming apparatuses can receive a request to join a level of a progressive. As another example, the gaming service 230 can operate a tournament style wagering game, and any of the collective gaming apparatuses can receive a request to join the tournament. As another example, the gaming service 230 can provide a skills-based game, and any of the collective gaming apparatus can receive a request to play the skills-based game. As another example, the gaming service 230 can provide a mini game, and any of the collective gaming apparatuses can receive a request to play the mini game.

In some other embodiments, the gaming service 230 can operate multiple wagering games at once, and each of the collective gaming apparatuses can receive a selection from a user indicating a particular wagering game for the request. In some other embodiments, the gaming service 230 can provide options related to the wagering game, including but not limited to, a size or quantity for the game subset and a size, quantity, and/or shape for the grid. Any of the collective gaming apparatuses can receive inputs from a user indicating a selection for a size or quantity for the game subset, and a size, quantity, and/or shape for the grid.

At step 312, the process 300 can include generating a card comprising a card subset arranged in an order. The collective gaming apparatuses or the game service 230 can generate a card comprising a card subset arranged in an order. The card subset can be generated by selecting indicia from the defined set of indicia. For example, the card subset can be selected from the defined set of indicia by using a random number generator or any other random selection process. The card subset can be organized or arranged in a random order by the random number generator or any other random selection process. For example, the game service 230 can anonymize the defined set of indicia, and each of the collective gaming apparatuses can receive inputs for a blind selection of the indicia for the game subset and/or the winning pattern. A card can be generated for each of the number of plays included in the request at the step 309.

In some embodiments, the collective gaming apparatuses can generate the card. In some other embodiments, the collective gaming apparatuses can transmit a request for the card to the gaming server 203 in response to receiving the request to play the wagering game at the step 309. In response, the game service 230 can generate and transmit the card back to the collective gaming apparatuses. Generating the card can include printing the card or rendering the card on a display.

At step 315, the process 300 can include determining an outcome and an award. The collective gaming apparatuses or the game service 230 can determine an outcome and an award. The outcome can be determined by comparing the card subset to the game subset. If the card subset includes any indicia matching the game subset and the matching indicia are arranged in a winning pattern (e.g., a game winning pattern or an interim winning pattern), the outcome can include a winning outcome. If the card subset does not include any indicia matching the game subset or the matching indicia are not arranged in a winning pattern, the outcome can include a losing outcome. The award can be determined based on the winning pattern. For example, different payouts can be assigned to each of the winning patterns selected at the step 303. As an example, the gaming winning pattern can have a higher payout than an interim winning pattern. As another example, the award can be based on an assigned level of a progressive. The award can be determined by multiplying the wager by the assigned payout.

In some embodiments, the collective gaming apparatuses can determine the outcome and award. In some other embodiments, the collective gaming apparatuses can transmit a request for the outcome and award to the gaming server 203. In response, the game service 230 can generate and transmit the outcome and award back to the collective gaming apparatuses. In some other embodiments, the game service 230 can transmit the outcome and award to the collective gaming apparatuses with the card generated at the step 312.

At step 318, the process 300 can include transmitting the outcome and the award to the gaming server 203. The collective gaming apparatuses can transmit the outcome and award to the gaming server 203. In response to receiving the outcome and award from the collective gaming apparatuses, the gaming server 203 can transmit a receipt confirmation back to the collective gaming apparatuses and save the outcome and award as the account data 236 and the gaming data 239. In some embodiments, the gaming server 203 can operate on a gaming kiosk 206 or a gaming device 209. In these embodiments, transmitting the outcome and award to the gaming server 203 may be unnecessary.

At step 321, the process 300 can include determining if the outcome includes a game ending outcome. The gaming server 203 can determine if the outcome includes a game ending outcome. For example, if the outcome is a losing outcome, the outcome may not include a game ending outcome and the process 300 can return to the step 309 to repeat. As another example, if the matching indicia from the card subset are arranged in an interim winning pattern, the outcome may not include a game ending outcome and the process 300 can return to the step 309 to repeat. As another example, if the matching indicia from the card subset are arranged in a game winning pattern, the outcome can include a game ending outcome and the process can proceed to the step 324.

At step 324, the process 300 can include terminating the wagering game. The gaming server 203 can terminating the wagering game by transmitting a message to the collective gaming apparatuses to stop accepting requests to play the wagering game. Terminating the wagering game can include no longer generating card subsets for the wagering game. For example, the gaming server can require that a new game subset be selected before generating any new card subsets. The gaming server 203 can transmit a game terminated message to the collective gaming apparatuses. In response, the collective gaming apparatuses can pause receiving requests to play the wagering game and display a message that requests cannot be received until a new wagering game is initiated. Once the wagering game has been terminated, the process 300 can return to step 303 to initiate a new wagering game and generate a new game subset. In some embodiments, the process 300 can end.

Referring now to FIG. 4, shown is an exemplary, wagering game process 400 according to various embodiments of the present disclosure. At step 403, the process 400 can include determining a game subset and a winning pattern. The collective gaming apparatuses can determine a game subset and a winning pattern. In some embodiments, the collective gaming apparatuses can determine the game subset and the winning pattern can include receiving the game subset and the winning pattern from the gaming server 203. In other embodiments, one of the collective gaming apparatuses (e.g., a gaming kiosk 206, a gaming device 209, a mobile gaming device 212) can determine the game subset and the winning pattern. In these embodiments, the collective gaming apparatus that determines the game subset and the winning pattern can transmit the game subset and the winning pattern to the other collective gaming apparatuses.

The game subset can be determined by randomly selecting indicia from the defined set of indicia. For example, the game subset can be selected from the defined set of indicia by using a random number generator. The winning pattern can be selected from the defined set of patterns by using a random number generator. For example, one or more game winning patterns and one or more interim winning patterns from the set of defined patterns.

At step 406, the process 400 can include receiving a request to play the wagering game. The collective gaming apparatuses can receive a request to play the wagering game. The request can be received by an input device on the respective gaming apparatus (e.g., gaming kiosk 206, gaming device 209, mobile gaming device 212) from a user. As will be understood, each of the collective gaming apparatuses can individually receive a request to play the wagering game and perform the steps 406-427. For example, if a gaming kiosk 206 receives a request to play the wagering game at the input device 260, the gaming kiosk 206 that received the request can perform the steps 406-427. As another example, if a gaming device 209 receives a request to play the wagering game at the input device 281, the gaming device 209 that received the request can perform the steps 406-427. As another example, if a mobile gaming device 212 receives a request to play the wagering game, the mobile gaming device 212 that received the request can perform the steps 406-427.

The request can include an account identifier (e.g., PIN number, account number, account username, email address, phone number) and/or account credentials. For example, the collective gaming apparatuses can transmit the account identifier and/or account credentials to the gaming server 203. The account service 224 can compare the account identifier and/or account credentials to the account data 236 and transmit a success or failure message to the collective gaming apparatuses based on the comparison. The request can include a number of plays. For example, the request can include one play or more than one plays (e.g., 2 plays, 5 plays, 10 plays, 100 plays). The request can include a wager (e.g., an amount being bet by the user for each play). The wager can include an amount of money or an amount of credits. For example, the gaming kiosk can accept the wager via the bill recycler 269. As another example, the gaming device 209 can accept the wager via the bill acceptor 287.

At step 409, the process 400 can include generating a card comprising a card subset arranged in an order. The collective gaming apparatus that received the request at the step 406 can generate the card. The card subset can be generated by randomly selecting indicia from the defined set of indicia. For example, the card subset can be selected from the defined set of indicia by using a random number generator. The card subset can be organized or arranged in a random order by the random number generator. For example, the card subset can be arranged in the order generated by the random number generator. A card can be generated for each of the number of plays included in the request at the step 406.

In some other embodiments, the collective gaming apparatuses can transmit a request for the card to the gaming server 203 in response to receiving the request to play the wagering game at the step 309. In response, the game service 230 can generate and transmit the card back to the collective gaming apparatuses.

At step 412, the process 400 can include printing the card comprising a QR code. The collective gaming apparatus can print the card comprising a QR code. For example, the gaming kiosk 206 can print the card using the printer 263 or the gaming device 209 can print the card using the printer 284. As another example, the mobile gaming device 212 can print the card using an external printing device. The printed card can be illustrated by the first card 103 shown in the FIG. 1. The printed card can include the game subset determined at the step 403 and the card subset determined at the step 409. The printed card can include a scannable code, including a bar code or a QR code. After the card is printed by the collective gaming apparatus, the user can optionally complete the card by marking the indicia in the card subset that match the indicia in the game subset. In some other embodiments, printing the card comprising the QR code can include rendering the card on a display.

At step 415, the process 400 can scanning the QR code. The collective gaming apparatus can scan QR code. For example, the gaming kiosk 206 can scan the card using the input device 260 or the gaming device 209 can scan the card using the input device 281. As another example, the mobile gaming device 212 can scan the card by using a camera or scanner. In response to scanning the QR code, the collective gaming apparatus can determine the outcome associated with the printed card. If the card subset is arranged in a game winning pattern, scanning the QR code can cause the wagering game to be terminated. For example, if the card includes a card subset arranged in a game winning pattern, the wagering game may not be terminated until the QR code is scanned. As will be understood, if the card includes a card subset arranged in a game winning pattern and the QR code is scanned, the gaming server 203 and/or the collective gaming apparatus can terminate the wagering game in response to the QR code being scanned.

In embodiments where the card is rendered on a display rather than printed, the display can include a selection to display an outcome. Any of the collective gaming apparatuses can receive an input to display the outcome and display the outcome in response. If the card includes a card subset arranged in a game winning pattern, receiving the input to display the outcome can cause the wagering game to be terminated. For example, if the card includes a car subset arranged in a game winning pattern, the wagering game may not be terminated until the input is received.

At step 418, the process 400 can include identifying a card resulting subset as an intersection of the game subset and the card subset. The collective gaming apparatus can identify a card resulting subset as an intersection of the game subset and the card subset. The card subset can be compared to the game subset to identify an intersection (e.g., indicia included in both the card subset and the game subset). The intersection can include any indicia in the card subset that match indicia in the game subset. The intersection can represent the card resulting subset. If the intersection is empty (e.g., none of the indicia in the card subset match the indicia in the game subset), the outcome can include a losing outcome. In some embodiments, the gaming server 203 can identify the intersection in response to receiving a request from the collective gaming apparatus.

At step 421, the process 400 can include performing a comparison of the card resulting subset arranged in the order to the winning patterns. The collective gaming apparatus can perform a comparison of the card resulting subset arranged in the order to the winning patterns. The card resulting subset can be arranged in an order based on the order of the card subset. For example, the order of the card resulting subset can include the order or position of the indicia in the card subset. The order of the card resulting subset can be compared to the winning patterns. If the order of the card resulting subset does not match a winning pattern, the outcome can include a losing outcome. If the order of the card resulting subset matches a winning pattern, the outcome can include a winning outcome. In some embodiments, the gaming server 203 can perform the comparison of the card resulting subset arranged in the order to the winning patterns.

At step 424, the process 400 can include determining an award based on the comparison. The collective gaming apparatus can determine an award based on the comparison. If the outcome is a winning outcome, the award can be determined based on the winning pattern. For example, different payouts can be assigned to each of the winning patterns selected at the step 403. As an example, the gaming winning pattern can have a higher payout than an interim winning pattern. The award can be determined by multiplying the wager by the assigned payout. The award can include an amount of money or an amount of credits. If the outcome is a losing outcome, the award can be no money or no credits. In some embodiments, the gaming server 203 can determine the award.

At step 427, the process 400 can include saving the award and the comparison. The collective gaming apparatus can transmit the award and comparison to the gaming server to be saved as the account data 236 and the gaming data 239. The step 427 can include printing the second card as illustrated by the second card 106 in the FIG. 1. The second card can include a marked game subset and a marked card subset. The marked card subset can include symbols (e.g., a cross, an X, a circle) indicating the card resulting subset. The marked card subset can illustrate the order of the card resulting subset. If the outcome is a winning outcome, the order or arrangement of the card resulting subset in the grid can include a winning pattern. The step 427 can include providing the award. For example, the gaming kiosk can pay out the award via the bill recycler 269. As another example, the gaming device 209 can print a ticket representing the award via the printer 284. As another example, the mobile gaming device 212 can pay out the award by associating the award with the user account.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporancously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.
Clause 1. A system, comprising: a kiosk device comprising at least one first processor configured to: determining a game subset from a plurality of indicia and a winning pattern from a plurality of patterns for a wagering game; transmit the game subset and the winning pattern to at least one gaming device; receive a request to play the wagering game via an input device of the kiosk device; generate a first card comprising a first card subset from the plurality of indicia arranged in a first randomly assigned order; determine a first outcome by: printing the first card comprising a QR code from a printing device coupled to the kiosk device to generate a printed first card; scanning the QR code from the printed first card; in response to scanning the QR code, identifying a first card resulting subset as an intersection of the game subset and the first card subset; performing a first comparison of the first card resulting subset as arranged in the first randomly assigned order to the plurality of patterns; and determining a first award for the first card based on the first comparison; receive an outcome indication for a second card from the at least one gaming device; and determine a second award for the second card based on a second comparison; the at least one gaming device comprising at least one second processor and being configured to: receive a request to play the wagering game via a first input device of the at least one gaming device; generate the second card comprising a second card subset from the plurality of indicia arranged in a second randomly assigned order; identify a second card resulting subset as the intersection of the game subset and the second card subset; perform the second comparison of the second card resulting subset as arranged in the second randomly assigned order to the plurality of patterns; and transmit a message to the kiosk device based on the second comparison.
Clause 2. The system of clause 1, wherein determining the game subset and the winning pattern comprises receiving the game subset and the winning pattern from a gaming server.
Clause 3. The system of clause 1, wherein the plurality of indicia of the first card subset are arranged in a grid.
Clause 4. The system of clause 1, wherein the game subset is determined based on a random number generator.
Clause 5. The system of clause 1, wherein each of the plurality of indicia comprise an integer.
Clause 6. A system, comprising: a memory device; and a kiosk device in communication with the memory device, the kiosk device comprising at least one processor configured to: initiate a wagering game by determining a game subset from a plurality of indicia and a winning pattern from a plurality of patterns; receive a request to play the wagering game via an input device of the kiosk device; generate a card comprising a card subset from the plurality of indicia arranged in a randomly assigned order; and determine an outcome by: printing the card comprising a QR code from a printing device coupled to the kiosk device to generate a printed card; scanning the QR code from the printed card; in response to scanning the QR code, identifying a card resulting subset as an intersection of the game subset and the card subset; performing a comparison of the card resulting subset as arranged in the randomly assigned order to the plurality of patterns; and determining an award for the card based on the comparison.
Clause 7. The system of clause 6, further comprising a ball service executable by a processor to randomly select the game subset from the plurality of indicia.
Clause 8. The system of clause 7, wherein randomly selecting each indicia in the game subset comprises: causing a respective physical ball to be selected from a plurality of physical balls individually corresponding to the plurality of indicia by separating the respective physical ball into a preset area; determining a respective indicia corresponding to the respective physical ball; and adding the respective indicia to the game subset.
Clause 9. The system of clause 7, wherein randomly selecting each indicia in the game subset comprises: causing a respective physical ball to be selected from a plurality of physical balls individually corresponding to the plurality of indicia by separating the respective physical ball into a preset area; determining a respective indicia corresponding to the respective physical ball; determining that the respective indicia is already in the game subset; and reject the respective physical ball from the preset area without adding a duplicate entry to the game subset.
Clause 10. The system of clause 9, wherein the at least one processor is further configured to determine the game subset from the plurality of indicia by receiving a message from a gaming service comprising the game subset.
Clause 11. The system of clause 9, wherein the at least one processor is further configured to determine the winning pattern from the plurality of patterns by receiving a message from a gaming service comprising the winning pattern.
Clause 12. The system of clause 9, wherein the at least one processor is further configured to: determine that the card resulting subset as arranged in the randomly assigned order matches the winning pattern based on the comparison; and in response to determining that the card resulting subset as arranged in the randomly assigned order matches the winning pattern, terminate the wagering game.
Clause 13. A method, comprising: initiating, via a gaming server comprising at least one processor, a wagering game by determining a game subset from a plurality of indicia and a winning pattern from a plurality of patterns; transmitting, via the gaming server, the game subset and the winning pattern to a kiosk device comprising at least one processor; receiving, via the kiosk device, a request to play the wagering game via an input device of the kiosk device; generating, via the kiosk device, a card comprising a card subset from the plurality of indicia arranged in a randomly assigned order; and determining, via the kiosk device, an outcome by: printing the card comprising a QR code from a printing device coupled to the kiosk device to generate a printed card; scanning the QR code from the printed card; in response to scanning the QR code, identifying a card resulting subset as an intersection of the game subset and the card subset; performing a comparison of the card resulting subset as arranged in the randomly assigned order to the plurality of patterns; and determining an award for the card based on the comparison; transmitting, via the kiosk device, the comparison to the gaming server; and terminating, via the gaming server, the wagering game based on the card resulting subset as arranged in the randomly assigned order matches the winning pattern.
Clause 14. The method of clause 13, wherein generating the card comprises selecting the card from a plurality of pregenerated cards.
Clause 15. The method of clause 13, wherein the plurality of indicia comprises a plurality of numbers.
Clause 16. The method of clause 13, wherein the winning pattern is randomly selected from the plurality of patterns.
Clause 17. The method of clause 13, wherein the card further comprises the card subset arranged in a grid.
Clause 18. The method of clause 13, wherein the card is configured to be marked indicating the card resulting subset.
Clause 19. The method of clause 13, wherein determining the award comprises multiplying a wager received with the request by an assigned payout factor.
Clause 20. The method of clause 13, further comprising: in response to scanning the QR code, printing, via the kiosk device, a second card comprising the card resulting subset.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a kiosk device comprising at least one first processor configured to:
determining a game subset from a plurality of indicia and a winning pattern from a plurality of patterns for a wagering game;
transmit the game subset and the winning pattern to at least one gaming device;
receive a request to play the wagering game via an input device of the kiosk device;
generate a first card comprising a first card subset from the plurality of indicia arranged in a first randomly assigned order;
determine a first outcome by:
printing the first card comprising a QR code from a printing device coupled to the kiosk device to generate a printed first card;
scanning the QR code from the printed first card;
in response to scanning the QR code, identifying a first card resulting subset as an intersection of the game subset and the first card subset;
performing a first comparison of the first card resulting subset as arranged in the first randomly assigned order to the plurality of patterns; and
determining a first award for the first card based on the first comparison;
receive an outcome indication for a second card from the at least one gaming device; and
determine a second award for the second card based on a second comparison;
the at least one gaming device comprising at least one second processor and being configured to:
receive a request to play the wagering game via a first input device of the at least one gaming device;
generate the second card comprising a second card subset from the plurality of indicia arranged in a second randomly assigned order;
identify a second card resulting subset as the intersection of the game subset and the second card subset;
perform the second comparison of the second card resulting subset as arranged in the second randomly assigned order to the plurality of patterns; and
transmit a message to the kiosk device based on the second comparison.

2. The system of claim 1, wherein determining the game subset and the winning pattern comprises receiving the game subset and the winning pattern from a gaming server.

3. The system of claim 1, wherein the plurality of indicia of the first card subset are arranged in a grid.

4. The system of claim 1, wherein the game subset is determined based on a random number generator.

5. The system of claim 1, wherein each of the plurality of indicia comprise an integer.

6. A system, comprising:
a memory device; and
a kiosk device in communication with the memory device, the kiosk device comprising at least one processor configured to:
initiate a wagering game by determining a game subset from a plurality of indicia and a winning pattern from a plurality of patterns;
receive a request to play the wagering game via an input device of the kiosk device;
generate a card comprising a card subset from the plurality of indicia arranged in a randomly assigned order; and
determine an outcome by:
printing the card comprising a QR code from a printing device coupled to the kiosk device to generate a printed card;
scanning the QR code from the printed card;
in response to scanning the QR code, identifying a card resulting subset as an intersection of the game subset and the card subset;
performing a comparison of the card resulting subset as arranged in the randomly assigned order to the plurality of patterns; and
determining an award for the card based on the comparison.

7. The system of claim 6, further comprising a ball service executable by a processor to randomly select the game subset from the plurality of indicia.

8. The system of claim 7, wherein randomly selecting each indicia in the game subset comprises:
causing a respective physical ball to be selected from a plurality of physical balls individually corresponding to the plurality of indicia by separating the respective physical ball into a preset area;
determining a respective indicia corresponding to the respective physical ball; and
adding the respective indicia to the game subset.

9. The system of claim 7, wherein randomly selecting each indicia in the game subset comprises:
causing a respective physical ball to be selected from a plurality of physical balls individually corresponding to the plurality of indicia by separating the respective physical ball into a preset area;
determining a respective indicia corresponding to the respective physical ball;
determining that the respective indicia is already in the game subset; and
reject the respective physical ball from the preset area without adding a duplicate entry to the game subset.

10. The system of claim 9, wherein the at least one processor is further configured to determine the game subset from the plurality of indicia by receiving a message from a gaming service comprising the game subset.

11. The system of claim 9, wherein the at least one processor is further configured to determine the winning pattern from the plurality of patterns by receiving a message from a gaming service comprising the winning pattern.

12. The system of claim 9, wherein the at least one processor is further configured to:
determine that the card resulting subset as arranged in the randomly assigned order matches the winning pattern based on the comparison; and
in response to determining that the card resulting subset as arranged in the randomly assigned order matches the winning pattern, terminate the wagering game.

13. A method, comprising:
initiating, via a gaming server comprising at least one processor, a wagering game by determining a game subset from a plurality of indicia and a winning pattern from a plurality of patterns;
transmitting, via the gaming server, the game subset and the winning pattern to a kiosk device comprising at least one processor;
receiving, via the kiosk device, a request to play the wagering game via an input device of the kiosk device;
generating, via the kiosk device, a card comprising a card subset from the plurality of indicia arranged in a randomly assigned order; and
determining, via the kiosk device, an outcome by:
printing the card comprising a QR code from a printing device coupled to the kiosk device to generate a printed card;
scanning the QR code from the printed card;
in response to scanning the QR code, identifying a card resulting subset as an intersection of the game subset and the card subset;
performing a comparison of the card resulting subset as arranged in the randomly assigned order to the plurality of patterns; and
determining an award for the card based on the comparison;
transmitting, via the kiosk device, the comparison to the gaming server; and
terminating, via the gaming server, the wagering game based on the card resulting subset as arranged in the randomly assigned order matches the winning pattern.

14. The method of claim 13, wherein generating the card comprises selecting the card from a plurality of pregenerated cards.

15. The method of claim 13, wherein the plurality of indicia comprises a plurality of numbers.

16. The method of claim 13, wherein the winning pattern is randomly selected from the plurality of patterns.

17. The method of claim 13, wherein the card further comprises the card subset arranged in a grid.

18. The method of claim 13, wherein the card is configured to be marked indicating the card resulting subset.

19. The method of claim 13, wherein determining the award comprises multiplying a wager received with the request by an assigned payout factor.

20. The method of claim 13, further comprising:
in response to scanning the QR code, printing, via the kiosk device, a second card comprising the card resulting subset.
